(19) United States
(12) Patent Application Publication
(10) Pub. No.: US 2024/0249659 A1
(43) Pub. Date: Jul. 25, 2024

(54) METHOD AND CIRCUIT FOR DRIVING DISPLAY PANEL, AND DISPLAY DEVICE

(71) Applicants: Hefei BOE Display Technology Co., Ltd., Hefei, Anjui (CN); BOE TECHNOLOGY GROUP CO., LTD., Beijing (CN)

(72) Inventors: Jianwei SUN, Beijing (CN); Liugang ZHOU, Beijing (CN); Jiao LIU, Beijing (CN); Jiantao LIU, Beijing (CN); Jun WANG, Beijing (CN); Yunyun LIANG, Beijing (CN); Qing LI, Beijing (CN)

(21) Appl. No.: 18/016,414

(22) PCT Filed: Feb. 28, 2022
(86) PCT No.: PCT/CN2022/078252

§ 371 Date: Jan. 16, 2023

(51) Int. Cl. G09G 3/20

(52) U.S. Cl. CPC G09G 3/2074; G09G 2300/0819; G09G 2310/08; G09G 2320/0285; G09G 2320/0626

(57) ABSTRACT

A method and a circuit for driving a display panel, and a display device are disclosed. The display panel includes rows of sub-pixels. The method includes a display process, which includes: generating an initial driving signal for each row of sub-pixels according to image information of an image to be displayed; adjusting the initial driving signal for each row of sub-pixels according to a compensation gain of each row of sub-pixels, so as to obtain a target driving signal, the compensation gain of each row of sub-pixels is an actual brightness coefficient of the row of sub-pixels with respect to a reference row of sub-pixels during the display panel displaying an image with a test gray scale; and driving each row of sub-pixels to display according to the target driving signal for the row of sub-pixels, so as to enable each row of sub-pixels to reach target brightness.

### TECHNICAL FIELD

The present disclosure relates to the field of display technology, and in particular, to a method and a circuit for driving a display panel, and a display device.

### BACKGROUND

With continuous development of display industry, liquid crystal display products have attracted more attention due to their advantages of low cost, narrow bezel, light weight, and the like, and Gate Driver on Array (GOA) technology has come into being in this background.

In a large-sized display product, a Timing Controller (TCON) provides a clock signal to a gate driving circuit, and thus a plurality of shift register units of the gate driving circuit sequentially output scanning signals to a plurality of gate lines. However, in practical applications, pulse widths of clock signals received by the shift register units are likely to be different, so that charging times of pixels in different rows are different, and further, horizontal stripes or lines are generated on a display screen.

### SUMMARY

The disclosure provides a method and a circuit for driving a display panel, and a display device.

In a first aspect, the present disclosure provides a method for driving a display panel, with the display panel including a plurality of rows of sub-pixels, the method including a display process, and the display process including: generating an initial driving signal for each row of sub-pixels according to image information of an image to be displayed; adjusting the initial driving signal for the row of sub-pixels according to a compensation gain of each row of sub-pixels stored in a preset compensation gain table, to obtain a target driving signal, with the compensation gain of each row of sub-pixels being an actual brightness coefficient of the row of sub-pixels with respect to a reference row of sub-pixels during the display panel displaying an image with a test gray scale; and driving the row of sub-pixels to display according to the target driving signal for the row of sub-pixels, so as to enable the row of sub-pixels to reach target brightness.

In some implementations, the initial driving signal includes an initial clock signal, and the adjusting the initial driving signal for the row of sub-pixels according to a compensation gain of each row of sub-pixels stored in a preset compensation gain table, includes: adjusting a time of a falling edge of the initial clock signal for each row of sub-pixels according to the compensation gain of each row of sub-pixels, so as to adjust a gate output enable time for each row of sub-pixels, with the adjusted gate out enable time for each row of sub-pixels being positively correlated with the compensation gain of each row of sub-pixels.

In some implementations, the initial driving signal includes an initial data output enable signal, and the adjusting the initial driving signal for the row of sub-pixels according to a compensation gain of each row of sub-pixels stored in a preset compensation gain table, includes: adjusting a time of a falling edge of the initial data output enable signal for each row of sub-pixels according to the compensation gain of each row of sub-pixels, so as to adjust an effective charging time for each row of sub-pixels, with the adjusted effective charging time for each row of sub-pixels being positively correlated with the compensation gain of each row of sub-pixels.

In some implementations, the initial driving signal includes an initial data signal, and the adjusting the initial driving signal for each row of sub-pixels according to a compensation gain of each row of sub-pixels stored in a preset compensation gain table, includes: adjusting an amplitude of the initial data signal for each row of sub-pixels according to the compensation gain of each row of sub-pixels, with the adjusted amplitude of the initial data signal being positively correlated with the compensation gain of each row of sub-pixels.

In some implementations, the method further includes a test process performed before the display process, and the test process includes: driving the display panel to display the image with the test gray scale; acquiring the image displayed by the display panel; determining actual brightness of each row of sub-pixels in the display panel according to the acquired image; determining the compensation gain of each row of sub-pixels according to the actual brightness of each row of sub-pixels and actual brightness of the reference row of sub-pixels, and generating the compensation gain table; and storing the compensation gain table.

In some implementations, the reference row of sub-pixels is a row of sub-pixels with lowest brightness during the display panel displaying the image with the test gray scale.

In some implementations, the test gray scale is greater than 200.

In a second aspect, the present disclosure provides a circuit for driving a display panel, with the display panel including a plurality of rows of sub-pixels, the circuit including: an initial signal generation module configured to generate an initial driving signal for each row of sub-pixels according to image information of an image to be displayed; a compensation module configured to adjust the initial driving signal for the row of sub-pixels according to a compensation gain of each row of sub-pixels stored in a preset compensation gain table, to obtain a target driving signal, with the compensation gain of each row of sub-pixels being an actual brightness coefficient of the row of sub-pixels with respect to a reference row of sub-pixels during the display panel displaying an image with a test gray scale; and a driving module configured to drive each row of sub-pixels to display according to the target driving signal for the row of sub-pixels, so as to enable each row of sub-pixels to reach target brightness.

In some implementations, the initial driving signal includes an initial clock signal, and the compensation module is configured to adjust a time of a falling edge of the initial clock signal for each row of sub-pixels according to the compensation gain of each row of sub-pixels, so as to adjust a gate out enable time of the row of sub-pixels, with the adjusted gate out enable time for each row of sub-pixels being positively correlated with the compensation gain of each row of sub-pixels.

In some implementations, the initial driving signal includes an initial data output enable signal, and the compensation module is configured to adjust a time of a falling edge of the initial data output enable signal for each row of sub-pixels according to the compensation gain of each row of sub-pixels, so as to adjust an effective charging time for each row of sub-pixels, with the adjusted effective charging time for each row of sub-pixels being positively correlated with the compensation gain of each row of sub-pixels.

In some implementations, the initial driving signal includes an initial data signal, and the compensation module is configured to adjust an amplitude of the initial data signal for each row of sub-pixels according to the compensation gain of each row of sub-pixels, with the adjusted amplitude of the initial data signal being positively correlated with the compensation gain of each row of sub-pixels.

In some implementations, the compensation gain table is generated by: driving the display panel to display the image with the test gray scale; acquiring the image displayed by the display panel; determining actual brightness of each row of sub-pixels in the display panel according to the acquired image; and determining the compensation gain of each row of sub-pixels according to the actual brightness of each row of sub-pixels and actual brightness of the reference row of sub-pixels, and generating the compensation gain table.

In some implementations, the circuit for driving the display panel further includes a storage module configured to store the compensation gain table.

In some implementations, the reference row of sub-pixels is a row of sub-pixels with lowest brightness during the display panel displaying the image with the test gray scale.

In some implementations, the test gray scale is greater than 200.

In a third aspect, the present disclosure provides a display device, including a display panel and the circuit for driving the display panel as described above.

### DESCRIPTION OF DRAWINGS

The accompanying drawings, which are included to provide a further understanding of the present disclosure and are incorporated in and constitute a part of the specification, and together with implementations serve to explain the present disclosure, but do not constitute a limitation of the present disclosure. In the drawings:

FIG. 1 is a schematic diagram of a connection between a timing controller and clock signal lines in an example;

FIG. 2 is a schematic diagram of a method for driving a display panel according to the present disclosure;

FIG. 3 is a schematic diagram of a test process according to the present disclosure;

FIG. 4 is a schematic diagram of a process of adjusting an initial clock signal according to the present disclosure;

FIG. 5 is a schematic structural diagram of a source driver chip according to the present disclosure;

FIG. 6 is a schematic diagram illustrating an adjustment of an initial driving signal for each row of sub-pixels according to the present disclosure; and

FIG. 7 is a schematic diagram of a circuit for driving a display panel according to the present disclosure.

### DESCRIPTION OF EMBODIMENTS

In order that those skilled in the art will better understand technical solutions of the present disclosure, the following detailed description is given with reference to the accompanying drawings and implementations.

Unless defined otherwise, technical or scientific terms used herein shall have the ordinary meaning as understood by one of ordinary skill in the art to which the present disclosure belongs. The use of “first,” “second,” and the like in the present disclosure is not intended to indicate any order, quantity, or importance, but rather is used to distinguish one element from another. Also, the use of the terms “a,” “an,” or “the” and similar referents does not denote a limitation of quantity, but rather denotes the presence of at least one. The word “comprise/comprising” or “include/including”, and the like, means that the element or item preceding the word contains the element or item listed after the word and its equivalent, but does not exclude other elements or items. The terms “connected” or “coupled” and the like are not restricted to physical or mechanical connections, but may include electrical connections, whether direct or indirect.

It should be noted that transistors used in the present disclosure may be thin film transistors or field effect transistors or other devices with the same characteristics, and since a source and a drain of each transistor are symmetrical, the source and the drain of each transistor are not different. In the present disclosure, to distinguish the source and the drain of each transistor, one of the source and the drain is referred to as a first electrode, the other one of the source and the drain is referred to as a second electrode, and a gate of each transistor is referred to as a control electrode. In addition, the transistors may be divided into N-type and P-type according to characteristics of the transistors, and in the following implementations, N-type transistors are used for explanation, and if the N-type transistors are used, the first electrode is the source of the N-type transistor, the second electrode is the drain of the N-type transistor, and in response to that a high level signal is input into the gate of the transistor, a current is allowed between the source and the drain of the transistor, that is, the source and the drain of the transistor are conducted, and for P-type transistors, the first electrode is the drain of the P-type transistor, the second electrode is the source of the P-type transistor, and in response to that a low level signal is input into the gate of the transistor, a current is allowed between the source and the drain of the transistor, that is, the source and the drain of the transistor are conducted. It is contemplated that, implementations with P-type transistors will be readily apparent to those skilled in the art without any creative effort, and thus are within the scope of the present disclosure. In the present disclosure, since N-type transistors are used, an operating level signal (operating level state) in the present disclosure refers to a high level signal (high level state), and a non-operating level signal is a low level signal (low level state), and accordingly, an operating level terminal is a high level signal terminal, and a non-operating level terminal is a low level signal terminal.

Generally, a display panel includes a plurality of gate lines and a plurality of data lines, the gate lines intersect with the data lines to define a plurality of pixel regions, and each of the pixel regions is provided therein with a thin film transistor. A structure of the display panel will be described by taking an extending direction in which each gate line extends being a row direction and an extending direction in which each data line extends being a column direction as an example. During driving the display panel to display, scanning signals may be written into the gate lines line by line according to an image to be displayed, and source voltage signals are written into the data lines simultaneously, so that the pixel regions of the display panel are lightened line by line. The scanning signals are provided by a gate driving circuit, and the source voltage signals are provided by a source driving circuit, and the source voltage signals are generated by performing a series of processing such as digital-to-analog conversion, level conversion and the like on a data signal provided by a timing controller, a timing sequence of outputting the source voltage signals by the source driving circuit is related to a Source Output Enable (SOE) signal output by the timing controller, and a start time of each source voltage signal is the same as a time of a falling edge of the SOE signal. In the related art, the gate driving circuit may be integrated in a gate driver chip, and the source driving circuit may be integrated in a source driver chip; in order to reduce the number of chips and realize a narrow bezel or no bezel, a technology (i.e., Gate On Array, GOA) for integrating the gate driving circuit on an array substrate is provided; the gate driving circuit includes a plurality of shift register units which are cascaded and integrated on the array substrate, the shift register units are connected with the gate lines in a correspondence mode one to one, and configured to provide scanning signals for the gate lines connected with the shift register units.

During driving the display panel to display, the timing controller provides clock signals to the shift register units through clock signal lines, and in an output stage of each shift register unit, the clock signal received by the shift register unit is in a high level state. However, since a resistance R of each clock signal line is relatively large, and a certain capacitance C (nF level) is formed between each clock signal line and a structure of metal, dielectric or the like, and the resistance R and the capacitance C may cause attenuation, delay, and/or deformation of signals, differences in pulse widths of the clock signals transmitted by different clock signal lines may be caused, thereby causing differences in pulse widths of the clock signals received by the shift register units connected to the different clock signal lines, and different charging times for pixels in different rows, which may cause a defect of horizontal strips or lines.

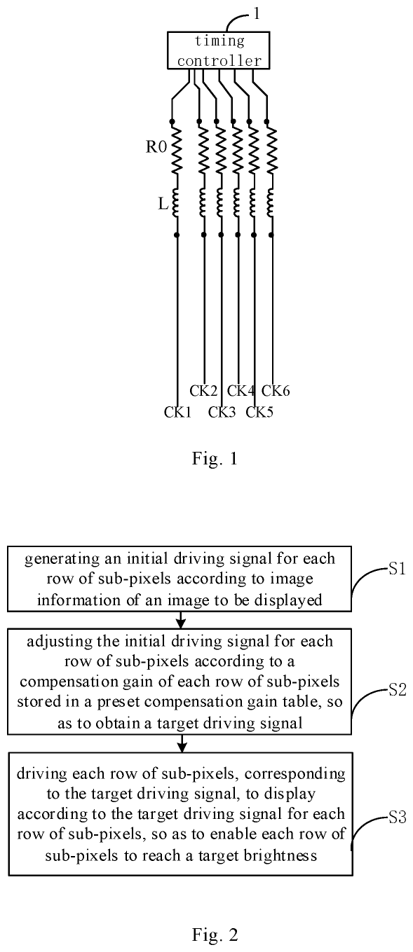

In addition, the resistance R and the capacitance C may cause attenuation, delay and deformation of signals, so that any clock signal may be not an ideal square wave signal but has a certain rising time and a certain falling time, and thus, the charging time for pixels may be insufficient. In some examples, a resistor RO and an inductor L (as shown in FIG. 1) are connected in series between the timing controller 1 and each clock signal line (CK1 to CK2) through a Resistance Inductor Tuning (RLT) technology, and an instantaneous back electromotive force is generated by storing energy through the inductor L, so as to reduce a falling time of the clock signal, but the resistor RO and the inductor L connected in series between the timing controller 1 and the clock signal line (CK1 to CK2) both have a certain precision range, so that a difference between the clock signals on different clock signal lines is amplified, and if the resistor RO and the inductor L connected in series with different clock signal lines significantly vary, the image displayed by the display panel has a significant defect of horizontal strips or lines. In order to solve the defect of horizontal stripes or lines of the display panel, the present disclosure provides a method and a circuit for driving a display panel, and a display device. The method and the circuit for driving a display panel, and the display device provided in the present disclosure will be further described in detail below in combination with the accompanying drawings.

FIG. 2 is a schematic diagram of a method for driving a display panel according to the present disclosure, the method is for driving the display panel to display, the display panel includes a plurality of gate lines and a plurality of data lines, the gate lines intersect with the data lines to define a plurality of sub-pixels, the sub-pixels are arranged in a plurality of rows and a plurality of columns, each row of sub-pixels may correspond to one gate line, and each column of sub-pixels may correspond to one data line. Specifically, each sub-pixel is provided therein with a thin film transistor, a gate of the thin film transistor is connected to the gate line corresponding thereto, and a source of the thin film transistor is connected to the data line corresponding thereto.

As shown in FIG. 2, the method includes a display process including following steps S1 to S3.

At step S1, generating an initial driving signal for each row of sub-pixels according to image information of an image to be displayed.

The initial driving signal may be generated by the timing controller, and the initial driving signal for each row of sub-pixels refers to an initial driving signal for each sub-pixel in each row, and the initial driving signal may include an initial clock signal, an initial data signal and an SOE signal (i.e., a data output enable signal). It should be understood that initial clock signals for the sub-pixels in a same row are the same, the initial data signal may be a digital signal, and an amplitude of the initial data signal for each sub-pixel is related to a gray scale to be displayed by the sub-pixel, and thus voltages of initial data signals for different sub-pixels in a same row may be different.

In some examples, the timing controller may generate the initial driving signal according to a preset timing and an original gray scale of an image to be displayed. Pulse widths of initial clock signals corresponding to different rows of sub-pixels are the same, and pulse widths of SOE signals for different sub-pixels in a same column are the same. The amplitude of the initial data signal for each sub-pixel is determined according to the original gray scale of the image to be displayed. In some implementations, the timing controller may generate an original clock signal and an original data signal for each row of sub-pixels according to a preset timing and an original gray scale of an image to be displayed, and then determine an intermediate gray scale of the image to be displayed according to a mura compensation table, and determine the initial driving signal for each sub-pixel according to the intermediate gray scale of the image to be displayed. The original gray scale of the image to be displayed is a gray scale before compensation is carried out by utilizing a brightness deviation elimination technology (e.g., a De-Mura technology), and the intermediate gray scale is a gray scale, corresponding to target brightness, that display brightness of the image to be displayed reaches by utilizing the De-Mura technology serving as a compensation technology to compensate the display brightness of the image to be displayed. The pulse widths of the initial clock signals corresponding to different rows of sub-pixels are the same, and the pulse widths of the SOE signals for the sub-pixels in a same column are the same. The amplitude of the initial data signal for each sub-pixel is determined according to the intermediate gray scale of the image to be displayed.

At step S2, adjusting the initial driving signal for each row of sub-pixels according to a compensation gain of each row of sub-pixels stored in a preset compensation gain table, so as to obtain a target driving signal, the compensation gain of each row of sub-pixels being an actual brightness gain of the row of sub-pixels with respect to a reference row of sub-pixels during the display panel displaying an image with a test gray scale.

The compensation gain table is obtained in a test process before the display process and may be stored in a storage module in the timing controller. The reference row of sub-pixels may be one row of sub-pixels in the display panel.

The target driving signal may include a target clock signal, a target data signal, and a target SOE signal, and the adjusting the initial driving signal according to the compensation gain may include adjusting the initial clock signal according to the compensation gain, so as to obtain the target clock signal in the target driving signal, or adjusting the initial data signal according to the compensation gain, so as to obtain the target data signal in the target driving signal, or adjusting an initial SOE signal according to the compensation gain, so as to obtain the target SOE signal in the target driving signal.

At step S3, driving each row of sub-pixels, corresponding to the target driving signal, to display according to the target driving signal for the row of sub-pixels, so as to enable each row of sub-pixels to reach target brightness.

In the present disclosure, the preset compensation gain table includes the compensation gain of each row of sub-pixels, and the compensation gain of each row of sub-pixels is the actual brightness gain of the row of sub-pixels with respect to the reference row of sub-pixels during the display panel displaying the image with the test gray scale; by adjusting the initial driving signal for each row of sub-pixels according to the compensation gain table, the brightness of each row of sub-pixels in the display panel may be compensated, so that each row of sub-pixels may finally reach the target brightness, and an occurring of the defect of horizontal stripes or lines may be reduced.

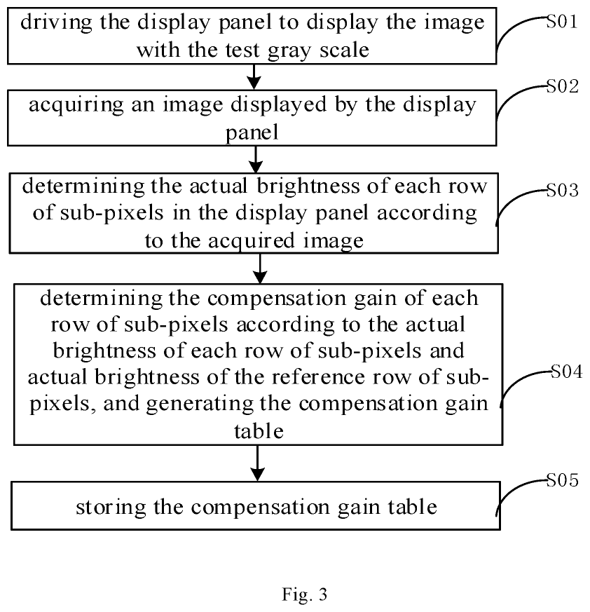

In some implementations, the method further includes a test process, and the compensation gain table may be generated in the test process, and FIG. 3 is a schematic diagram of a test process according to the present disclosure, and as shown in FIG. 3, the test process includes following steps S01 to S05.

At step S01, driving the display panel to display the image with the test gray scale.

In an example, the test gray scale is greater than 200, or, the test gray scale ranges from 220 to 255. For example, the test gray scale may be 223, 230, 233, 240, 250 or 255.

In some implementations, the image, with the test gray scale, displayed by the display panel is an image, with brightness compensated by using the De-mura technology, and thus no defect of mura occurs in the image displayed on the display panel. However, the De-mura technology cannot improve the defect of horizontal stripes or lines in an image with a relatively high gray scale, that is, in step S01, the image displayed on the display panel may have the defect of horizontal stripes or lines due to a difference between the clock signals on the clock signal lines.

At step S02, acquiring an image displayed by the display panel.

At S03, determining the actual brightness of each row of sub-pixels in the display panel according to the acquired image.

At S04, determining the compensation gain of each row of sub-pixels according to the actual brightness of each row of sub-pixels and actual brightness of the reference row of sub-pixels, and generating the compensation gain table.

In some implementations, the reference row of sub-pixels is one row of sub-pixels in the display panel with lowest brightness. Table 1 is an actual brightness table of each row of sub-pixels according to the present disclosure, and Table 2 is a compensation gain table according to the present disclosure, as shown in Tables 1 and 2, the brightness of each of the third row and the ninth row of sub-pixels is the lowest, and one of the third row and the ninth row of sub-pixels is taken as the reference row of sub-pixels, the actual brightness of the i^{th} row of sub-pixels is denoted as Li, the brightness of the reference row of sub-pixels is denoted as L0, and the compensation gain of the i^{th} row of sub-pixels is denoted as Gain_i, then Gain_i=Li/L0, thereby obtaining the compensation gain table shown in Table 2.

TABLE 1

| | actual brightness |
|---|---|
| first row of sub-pixels | 200 |
| second row of sub-pixels | 200 |
| third row of sub-pixels | 180 |
| fourth row of sub-pixels | 199 |
| fifth row of sub-pixels | 197 |
| sixth row of sub-pixels | 198 |
| seventh row of sub-pixels | 200 |
| eight row of sub-pixels | 200 |
| ninth row of sub-pixels | 180 |
| tenth row of sub-pixel | 201 |
| eleventh row of sub-pixels | 202 |
| twelfth row of sub-pixels | 198 |
| . . . | . . . |

TABLE 2

| | compensation gain |
|---|---|
| first row of sub-pixels | 1.111 |
| second row of sub-pixels | 1.111 |
| third row of sub-pixels | 1 |
| fourth row of sub-pixels | 1.106 |
| fifth row of sub-pixels | 1.1 |
| sixth row of sub-pixels | 1.094 |
| seventh row of sub-pixels | 1.111 |
| eight row of sub-pixels | 1.111 |
| ninth row of sub-pixels | 1 |
| tenth row of sub-pixel | 1.106 |
| eleventh row of sub-pixels | 1.1 |
| twelfth row of sub-pixels | 1.094 |
| . . . | . . . |

At step S05, storing the compensation gain table.

Several manners of adjusting the initial driving signal according to the compensation gain table are described in detail below. A case where the timing controller provides the clock signals to the shift register units through six clock signal lines is taken as an example for description. Specifically, the shift register unit at the (1+6n)^{th} stage is connected to a first clock signal line, the shift register unit at the (2+6n)^{th} stage is connected to a second clock signal line, the shift register unit at the (3+6n)^{th} stage is connected to a third clock signal line, the shift register unit at the (4+6n)^{th} stage is connected to a fourth clock signal line, the shift register unit at the (5+6n)^{th} stage is connected to a fifth clock signal line, the shift register unit at the (6+6n)^{th} stage is connected to a sixth clock signal line, n is an integer, and n is greater than or equal to 0. Initial clock signals for the rows of sub-pixels corresponding to the shift register units connected with a same clock signal line are the same, target clock signals for the rows of sub-pixels corresponding to the shift register units connected with a same clock signal line are also the same, and the target clock signals are provided to the clock signal lines by the timing controller.

In a first manner, the initial clock signal may be adjusted. The step S2 may include: adjusting a time of a falling edge of the initial clock signal for each row of sub-pixels according to the compensation gain of each row of sub-pixels, so as to adjust a gate output enable (GOE) time for each row of sub-pixels, and before adjusting the initial clock signal, GOE times of the rows of sub-pixels may be the same. The adjusted gate output enable time for each row of sub-pixels is positively correlated with the compensation gain of each row of sub-pixels.

It should be noted that, the gate output enable signal (GOE) of each row of sub-pixels is an interval time between the falling edge of the clock signal for each row of sub-pixels and a start time of a source voltage signal for a next row of sub-pixels, i.e., an interval time between the falling edge of the clock signal for each row of sub-pixels and the falling edge of the SOE signal for the next row of sub-pixels. The GOE time is set to prevent miss-charging, and after a scanning stage of each row of sub-pixels is finished, thin film transistors in the sub-pixels in the row are not turned off instantly, and if the GOE time is not set, once the thin film transistors in the row are not turned off completely and source voltage signals for the sub-pixels in the next row are already output to the data lines, miss-charging phenomenon may occur. The scanning stage of a certain row of sub-pixels refers to the output stage of the shift register unit corresponding to the row of sub-pixels.

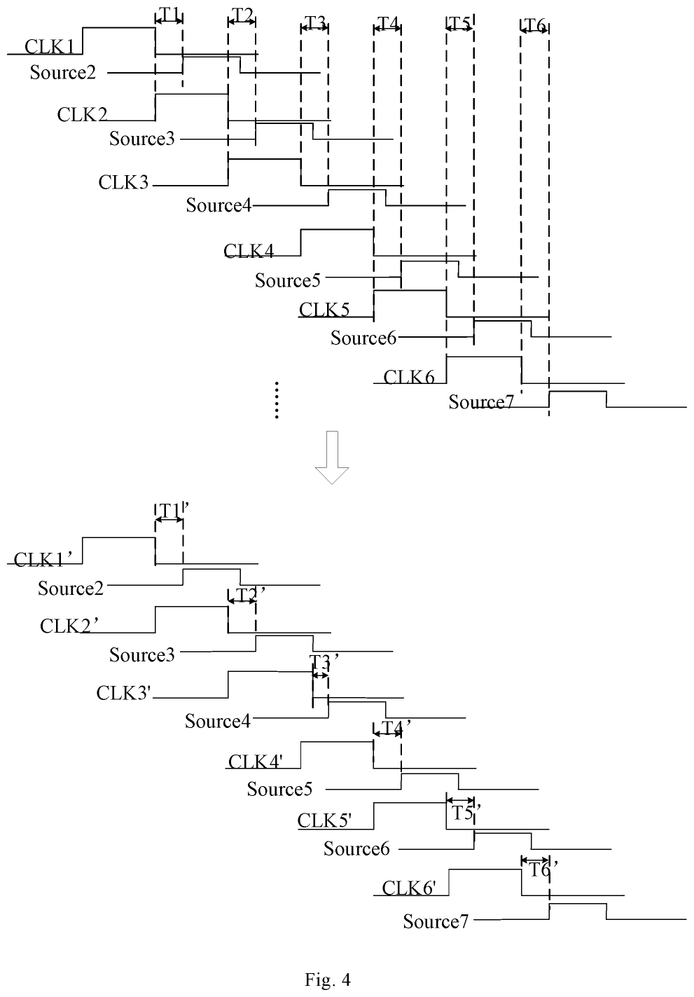

FIG. 4 is a schematic diagram illustrating a process of adjusting an initial clock signal according to the present disclosure, and in FIG. 4, the process of adjusting the initial clock signal for six rows of sub-pixels is taken as an example for description, and a principle of adjusting the remaining rows of sub-pixels is the same. CLK1 to CLK6 are the initial clock signals for the first row of sub-pixels to the sixth row of sub-pixels, and CLK1′ to CLK6′ are the target clock signals of the first row of sub-pixels to the sixth row of sub-pixels. Source2 to Source7 are source voltage signals for the second row of sub-pixels to the seventh row of sub-pixels, respectively. T1 to T6 are GOE times, before being adjusted, for the first row of sub-pixels to the sixth row of sub-pixels, respectively, and T1 ‘to T6’ are GOE times, after being adjusted, for the first row of sub-pixels to the sixth row of sub-pixels, respectively. Before and after the initial clock signals are adjusted, the source voltage signals of the rows of sub-pixels are not changed.

It should be noted that each of the initial clock signal and the target clock signal for each row of sub-pixels is a clock signal that is switched between a high level state and a low level state, and in FIG. 4, to illustrate the initial clock signal/the source voltage signal for each row of sub-pixels, only one high level state is shown.

For the compensation gain table shown in Table 2 above, the third row of sub-pixels of the display panel appears dark-striped, in such case, the pulse width of CLK3 may be increased, i.e., the falling edge of CLK3 is shifted backward with respect to CLK1, so as to reduce the GOE time of the third row of sub-pixels (from T3 to T3′), which is beneficial to increase the charging time for the third row of sub-pixels, thereby increasing the brightness of the third row of sub-pixels.

In some implementations, the adjusted GOE time of the i^{th} row of sub-pixels satisfies the following relationship: Ti′=T0×Gain_i×A, where Ti′ is the adjusted GOE time of the i^{th} row of sub-pixels, T0 is the adjusted GOE time of the reference row of sub-pixels, and in FIG. 4, T3′ is T0; A is a proportionality coefficient relating to a charging rate of the display panel, and the charging rate of the display panel is equal to a ratio of actual brightness to theoretical brightness of the display panel.

In the first manner, only the initial clock signal in the initial driving signal may be adjusted, and the initial data signal may not be adjusted. The adjusted initial clock signal is the target clock signal, the target data signal is the same as the initial data signal, and the target SOE signal is the same as the initial SOE signal.

In a second manner, the initial SOE signal may be adjusted. The step S2 may include: adjusting a time of a falling edge of the initial SOE signal for each row of sub-pixels according to the compensation gain of each row of sub-pixels, so as to adjust a start time of the source driver chip for outputting the source voltage signal, thereby adjusting an effective charging time for each row of sub-pixels, and the adjusted effective charging time for each row of sub-pixels is positively correlated with the compensation gain of each row of the sub-pixels.

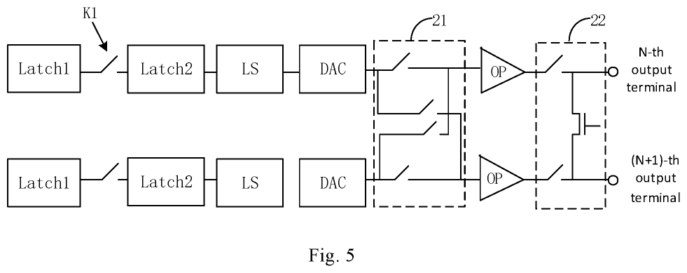

The SOE signal is configured for controlling the time of the source driver chip for outputting the source voltage signal. FIG. 5 is a schematic structural diagram of a source driver chip according to the present disclosure, and as shown in FIG. 5, the source driver chip includes a first buffer unit Latch1, a gating switch K1, a second buffer unit Latch2, a level converter LS, a digital-to-analog converter DAC, a polarity control unit 21, an amplifier OP and an output control unit 22. The target data signal output by the timing controller is first stored in the first buffer Latch1, and if the gating switch K1 is turned on in response to a gate signal, the target data signal is transmitted to the second buffer Latch2, and then the target data signal is level-converted by the level converter LS and digital-to-analog-converted by the digital-to-analog converter DAC to generate an analog signal. The polarity control unit 22 controls a polarity of the analog signal, so as to control the polarity of the analog signal as desired, for example, in an example, the N^{th} output terminal of the source driver chip is desired to output a voltage signal with a positive polarity, and the (N+1)^{th} output terminal of the source driver chip is desired to output a voltage signal with a negative polarity, by controlling through a plurality of switches inside the polarity control unit 21, the polarity control unit 21 makes the analog-to-digital converter DAC corresponding to the N^{th} output terminal output an analog signal with a positive polarity and transmit the analog signal to a corresponding amplifier OP, and makes the analog-to-digital converter DAC corresponding to the (N+1)^{th} output terminal output an analogy signal with a negative polarity and transmit the analog signal to a corresponding amplifier OP. The output control unit 22 transmits the voltage signal output from each amplifier OP to a corresponding output terminal of the source driving circuit in response to a falling edge of the SOE signal.

The effective charging time for each row of sub-pixels is an overlapping time between a high level duration of the clock signal for the row of sub-pixels and an active period of the source voltage signal. It should be noted that the “active period” of the source voltage signal does not include a transition period between an inactive period and the active period. For the present disclosure, the effective charging time, before being adjusted, for each row of sub-pixels is the overlapping time between the high level duration of the initial clock signal and the active period of the source voltage signal before being adjusted; the effective charging time, after being adjusted, is the overlapping time between the high level duration of the target clock signal and the active period of the source voltage signal after being adjusted. Since the source voltage signal is output by the source driver chip in response to the falling edge of the SOE signal, the effective charging time for the sub-pixels can be adjusted by adjusting the time of the falling edge of the SOE signal.

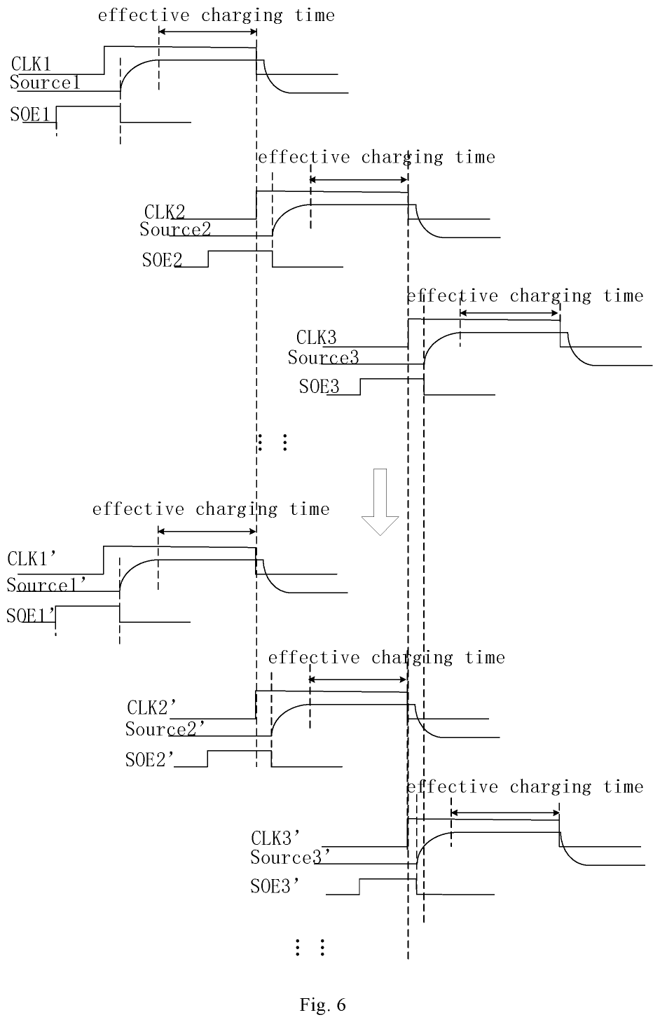

FIG. 6 is a schematic diagram illustrating an adjustment of an initial driving signal for each row of sub-pixels according to the present disclosure, and only three rows of sub-pixels are taken as an example in FIG. 6. As shown in FIG. 6, CLK1 to CLK3 are initial clock signals for first three rows of sub-pixels, and CLK1′ to CLK3′ are target clock signals for the first three rows of sub-pixels, respectively, and the target clock signal for each row of sub-pixels may be the same as the initial clock signal for the row of sub-pixels. SOE1 to SOE3 are initial SOE signals for the first three rows of sub-pixels respectively, and SOE1′ to SOE3′ are target SOE signals for the first three rows of sub-pixels respectively. Source 1 to Source 3 are source voltage signals, before being adjusted, for the first row of sub-pixels to the third row of sub-pixels, respectively, and Source1′ to Source3′ are source voltage signals, after being adjusted, for the first row of sub-pixels to the third row of sub-pixels, respectively. The effective charging times, before being adjusted, for the rows of sub-pixels may be equal.

For the compensation gain table shown in Table 2 above, since the compensation gain of the third row of sub-pixels is smaller, the falling edge of SOE3 can be moved forward, so that the falling edge of SOE3′ is advanced from SOE1′ and SOE2′, thereby increasing the effective charging time for the third row of sub-pixels and further improving the brightness of the third row of sub-pixels. In addition, a rising edge of the initial SOE signal may not be adjusted during adjusting the initial SOE signal.

In a third manner, the amplitude of the initial data signal may be adjusted. Specifically, the amplitude of the initial data signal for each row of sub-pixels may be adjusted according to the compensation gain of each row of sub-pixels, the adjusted amplitude of the initial data signal is positively correlated with the compensation gain of each row of sub-pixels. In the third manner, the adjusted initial data signal is the target data signal in the target driving signal, and the target clock signal and the target SOE signal may be respectively the same as the initial clock signal and the initial SOE signal.

The amplitude of the target data signal may be determined according to a preset correspondence table.

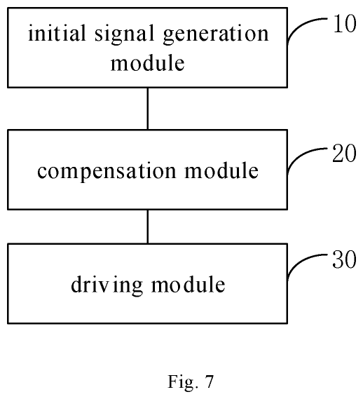

FIG. 7 is a schematic diagram of a circuit for driving a display panel according to the present disclosure, and as shown in FIG. 7, the circuit includes: an initial signal generation module 10, a compensation module 20 and a driving module 30.

The initial signal generation module 10 is configured to generate an initial driving signal for each row of sub-pixels according to image information of an image to be displayed. The initial driving signal may include an initial clock signal, an initial data signal, and an initial SOE signal.

The compensation module 20 is configured to adjust the initial driving signal for each row of sub-pixels according to the compensation gain of each row of sub-pixels stored in a preset compensation gain table, so as to obtain a target driving signal, the compensation gain of each row of sub-pixels being an actual brightness coefficient of the row of sub-pixels with respect to a reference row of sub-pixels during the display panel displaying an image with a test gray scale.

The driving module 30 is configured to drive each row of sub-pixels to display according to the target driving signal for the row of sub-pixels, so that each row of sub-pixels reach the target brightness.

The initial signal generation module 10 and the compensation module 20 may be integrated in the timing controller, and the driving module 30 may include a gate driving circuit and a source driving circuit.

In some implementations, the compensation module 20 is configured to adjust a time of a falling edge of the initial clock signal for each row of sub-pixels according to the compensation gain of each row of sub-pixels, so as to adjust a gate output enable time for each row of sub-pixels, and the adjusted gate output enable time for each row of sub-pixels is positively correlated with the compensation gain of each row of the sub-pixels.

For the process for adjusting the initial clock signal, reference may be made to the above description, and the description thereof will not be repeated here.

In some implementations, the compensation module 20 is configured to adjust a time of a falling edge of the initial SOE signal for each row of sub-pixels according to the compensation gain of each row of sub-pixels, so as to adjust an effective charging time for each row of sub-pixels, and the adjusted effective charging time for each row of sub-pixels is positively correlated to the compensation gain of each row of sub-pixels.

For the process for adjusting the initial SOE signal, reference may be made to the above description, and the description thereof will not be repeated here.

In some implementations, the compensation module 20 is configured to adjust an amplitude of the initial data signal for each row of sub-pixels according to the compensation gain of each row of sub-pixels, and the adjusted amplitude of the initial data signal is positively correlated with the compensation gain of each row of sub-pixels.

For the process for adjusting the initial data signal, reference may be made to the above description, and the description thereof will not be repeated here.

In some implementations, the compensation gain table is generated by: driving the display panel to display the image with the test gray scale; acquiring an image displayed by the display panel; determining actual brightness of each row of sub-pixels in the display panel according to the acquired image; and determining the compensation gain of each row of sub-pixels according to the actual brightness of each row of sub-pixels and actual brightness of a reference row of sub-pixels, and generating the compensation gain table. In some implementations, the reference row of sub-pixels is the row of sub-pixels with lowest brightness during the display panel displaying the image with the test gray scale. In some implementations, the test gray scale is greater than 200.

The circuit for driving the display panel may further include a storage module configured to store the compensation gain table. The compensation gain table may be generated in a test process before a display process, and the timing controller may adjust the initial driving signal by calling the compensation gain table stored in the storage module for displaying an image in the display process, thereby generating the target driving signal. By adjusting the initial driving signal, a charging difference, between different rows of sub-pixels, caused by a resistance difference between the clock signal lines and the like can be compensated, so that the defect of horizontal stripes or lines is reduced, and an improved display effect is resulted.

The present disclosure further provides a display device, including a display panel and the circuit for driving the display panel according to the present disclosure. The display device may be any product or component with a display function, such as electronic paper, a mobile phone, a tablet computer, a television, a display, a notebook computer, a digital photo frame, a navigator and the like.

It will be understood that the above implementations are merely exemplary implementations employed to illustrate the principles of the present disclosure, and the present disclosure is not limited thereto. It will be apparent to those skilled in the art that various changes and modifications may be made without departing from the spirit and scope of the present disclosure, and these changes and modifications are to be considered within the scope of the present disclosure.

1. A method for driving a display panel comprising a plurality of rows of sub-pixels, the method comprising a display process comprising:
generating an initial driving signal for each row of sub-pixels according to image information of an image to be displayed;
adjusting the initial driving signal for each row of sub-pixels according to a compensation gain of each row of sub-pixels stored in a preset compensation gain table, so as to obtain a target driving signal, with the compensation gain of each row of sub-pixels being an actual brightness coefficient of the row of sub-pixels with respect to a reference row of sub-pixels during the display panel displaying an image with a test gray scale; and
driving each row of sub-pixels to display according to the target driving signal for the row of sub-pixels, so as to enable each row of sub-pixels to reach target brightness.

2. The method according to claim 1, wherein the initial driving signal includes an initial clock signal, and the adjusting the initial driving signal for each row of sub-pixels according to a compensation gain of each row of sub-pixels stored in a preset compensation gain table, comprising:
adjusting a time of a falling edge of the initial clock signal for each row of sub-pixels according to the compensation gain of each row of sub-pixels, so as to adjust a gate output enable time for each row of sub-pixels, the adjusted gate output enable time for each row of sub-pixels being positively correlated with the compensation gain of each row of sub-pixels.

3. The method according to claim 1, wherein the initial driving signal includes an initial data output enable signal, and the adjusting the initial driving signal for each row of sub-pixels according to a compensation gain of each row of sub-pixels stored in a preset compensation gain table, comprising:
adjusting a time of a falling edge of the initial data output enable signal for each row of sub-pixels according to the compensation gain of each row of sub-pixels, so as to adjust an effective charging time for each row of sub-pixels, the adjusted effective charging time for each row of sub-pixels being positively correlated with the compensation gain of each row of sub-pixels.

4. The method according to claim 1, wherein the initial driving signal comprises an initial data signal, and the adjusting the initial driving signal for each row of sub-pixels according to the compensation gain of each row of sub-pixels stored in a preset compensation gain table, comprising:
adjusting an amplitude of the initial data signal for each row of sub-pixels according to the compensation gain of each row of sub-pixels, the adjusted amplitude of the initial data signal being positively correlated with the compensation gain of each row of sub-pixels.

5. The method according to claim 1, further comprising a test process performed before the display process, the test process comprising:
driving the display panel to display the image with the test gray scale;
acquiring an image displayed by the display panel;
determining actual brightness of each row of sub-pixels in the display panel according to the acquired image;
determining the compensation gain of each row of sub-pixels according to the actual brightness of each row of sub-pixels and actual brightness of a reference row of sub-pixels, and generating the compensation gain table; and
storing the compensation gain table.

6. The method according to claim 1, wherein the reference row of sub-pixels is a row of sub-pixels with lowest brightness during the display panel displaying the image with the test gray scale.

7. The method according to claim 1, wherein the test gray scale is greater than 200.

8. A circuit for driving a display panel, the display panel including a plurality of rows of sub-pixels, the circuit comprising:
an initial signal generation module configured to generate an initial driving signal for each row of the sub-pixels according to image information of an image to be displayed;
a compensation module configured to adjust the initial driving signal for the row of sub-pixels according to a compensation gain of each row of sub-pixels stored in a preset compensation gain table, so as to obtain a target driving signal, with the compensation gain of each row of sub-pixels being an actual brightness coefficient of the row of sub-pixels with respect to a reference row of sub-pixels during the display panel displaying an image with a test gray scale; and
a driving module configured to drive each row of sub-pixels to display according to the target driving signal for the row of the sub-pixels, so that each row of the sub-pixels reach target brightness.

9. The circuit according to claim 8, wherein the initial driving signal comprises an initial clock signal, and the compensation module is configured to adjust a time of a falling edge of the initial clock signal for each row of sub-pixels according to the compensation gain of each row of sub-pixels, so as to adjust a gate output enable time for each row of sub-pixels, and the adjusted gate output enable time of each row of sub-pixels is positively correlated with the compensation gain of each row of sub-pixels.

10. The circuit according to claim 8, wherein the initial driving signal comprises an initial data output enable signal, and the compensation module is configured to adjust a time of a falling edge of the initial data output enable signal for each row of sub-pixels according to the compensation gain of each row of sub-pixels, so as to adjust an effective charging time for each row of sub-pixels, and the adjusted effective charging time of each row of sub-pixels is positively correlated with the compensation gain of each row of sub-pixels.

11. The circuit according to claim 8, wherein the initial driving signal comprises an initial data signal, and the compensation module is configured to adjust an amplitude of the initial data signal for each row of sub-pixels according to the compensation gain of each row of sub-pixels, and the adjusted amplitude of the initial data signal is positively correlated with the compensation gain of each row of sub-pixels.

12. The circuit according to claim 8, wherein the compensation gain table is generated by:
driving the display panel to display the image with the test gray scale;
acquiring an image displayed by the display panel;
determining actual brightness of each row of sub-pixels in the display panel according to the acquired image; and
determining the compensation gain of each row of sub-pixels according to the actual brightness of each row of sub-pixels and actual brightness of a reference row of sub-pixels, and generating the compensation gain table.

13. The circuit according to claim 8, further comprising a storage module configured to store the compensation gain table.

14. The circuit according to claim 8, wherein the reference row of sub-pixels is a row of sub-pixels with lowest brightness during the display panel displaying the image with the test gray scale.

15. The circuit according to claim 8, wherein the test gray scale is greater than 200.

16. A display device, comprising a display panel and the circuit according to claim 8.

17. The method according to claim 2, further comprising a test process performed before the display process, the test process comprising:
driving the display panel to display the image with the test gray scale;
acquiring an image displayed by the display panel;
determining actual brightness of each row of sub-pixels in the display panel according to the acquired image;
determining the compensation gain of each row of sub-pixels according to the actual brightness of each row of sub-pixels and actual brightness of a reference row of sub-pixels, and generating the compensation gain table; and
storing the compensation gain table.

18. The method according to claim 3, further comprising a test process performed before the display process, the test process comprising:
driving the display panel to display the image with the test gray scale;
acquiring an image displayed by the display panel;
determining actual brightness of each row of sub-pixels in the display panel according to the acquired image;
determining the compensation gain of each row of sub-pixels according to the actual brightness of each row of sub-pixels and actual brightness of a reference row of sub-pixels, and generating the compensation gain table; and
storing the compensation gain table.

19. The method according to claim 4, further comprising a test process performed before the display process, the test process comprising:
driving the display panel to display the image with the test gray scale;
acquiring an image displayed by the display panel;
determining actual brightness of each row of sub-pixels in the display panel according to the acquired image;
determining the compensation gain of each row of sub-pixels according to the actual brightness of each row of sub-pixels and actual brightness of a reference row of sub-pixels, and generating the compensation gain table; and
storing the compensation gain table.

20. The method according to claim 2, wherein the reference row of sub-pixels is a row of sub-pixels with lowest brightness during the display panel displaying the image with the test gray scale.
